(19) United States
(12) Patent Application Publication
(10) Pub. No.: US 2012/0050623 A1
(43) Pub. Date: Mar. 1, 2012

(54) VIDEO DISPLAY APPARATUS AND PROJECTION TYPE VIDEO DISPLAY APPARATUS

(75) Inventors: Masahiro HARAGUCHI, Osaka (JP); Masutaka Inoue, Osaka (JP); Tomoya Terauchi, Osaka (JP); Takaaki Abe, Osaka (JP)

(73) Assignee: Sanyo Electric Co., Ltd., Osaka (JP)

(21) Appl. No.: 13/222,491

(22) Filed: Aug. 31, 2011

(30) Foreign Application Priority Data
Aug. 31, 2010 (JP) 2010-193698

(51) Int. Cl. H04N 9/31

(52) U.S. Cl. 348/760; 348/E05.139

(57) ABSTRACT

A video display apparatus includes a light source unit that includes a plurality of single-color light sources emitting light beams of different wavelengths and a control unit that controls actuation of the light source unit. The control unit sets a single-color light emission period in which at least two single-color light sources of the plurality of single-color light sources emit the light beams in a time division manner and a multiple-color light emission period in which at least two single-color light sources of the plurality of single-color light sources emit the light beams simultaneously, within one frame period, based on a result of analyzing the video signal for each image data on a frame basis. Further, the control unit changes a ratio between amounts of the light beams emitted from at least two single-color light sources in the multiple-color light emission period, in accordance with the image data.

### BACKGROUND OF THE INVENTION

1. Field of the Invention

This invention relates to a video display apparatus and a projection type video display apparatus each including a light source part in which a plurality of single-color light sources emit light beams of different wavelengths in a time division manner.

2. Description of the Related Art

A video displaying method of improving the brightness of an output video by use of a white component in addition to three primary R, G and B components has been disclosed for a field sequential drive type video display apparatus in which a plurality of single-color light sources emit light beams sequentially in a time division manner. This video displaying method includes a step of extracting a white component from a primary color video signal, a step of calculating a zone for displaying the white component, a step of converting the primary color video signal into a time-reduced primary color video signal and a white video signal, based on the white component display zone, and a step of driving single-color light sources simultaneously in a zone for displaying the white video signal and driving the single-color light sources sequentially in a zone for displaying the time-reduced primary color video signal. According to this video displaying method, a white video is displayed by driving the single-color light sources simultaneously, based on a ratio of a minimum gradation to a maximum gradation in the primary color signal. Thus, an output video is improved in brightness.

According to the video displaying method, in the step of extracting the white component from the primary color video signal, the white component is extracted with the minimum gradations of the R, G and B video signals as a basis. In the white component display zone, then, all the single-color light sources are driven simultaneously to activate all pixels at the maximum gradation, so that the white video signal is displayed.

According to the video displaying method, the white component is extracted with the minimum gradations of the R, G and B video signals as a basis. Consequently, in a case where black (all the R, G and B components are zero) or red (the R component is maximum, and the G and B components are zero) is contained on one image area, for example, the white component to be extracted is zero. Accordingly, there arises a disadvantage that a typical video rarely enjoys an effect of achieving high brightness.

In the video displaying method, on the other hand, it is effective to set the white component display zone to be longer as much as possible in order to obtain a high-brightness output video for the following reason. That is, it is possible to reduce a sum total of the display zones for the R, G and B components as well as the display zone for the white component by setting the white component display zone to be longer, and therefore it is possible to enlarge a ratio at the time of performing scaling such that the sum total matches with a frame zone.

Herein, it is required to maximize the white components to be extracted from the R, G and B video signals in order to set the white component display zone to be longer. When the white components to be extracted from the R, G and B video signals are maximized, an output video can be improved in brightness. In the white component display zone, however, all the single-color light sources are driven simultaneously to display the primary color video signals at the maximum possible gradations. Consequently, there arises a possibility that the single-color light source emits a light beam in an amount exceeding a required amount for displaying the white component. As the result, there arises a problem that the amount of the light beam to be emitted from the single-color light source is increased excessively and the single-color light source consumes electric power wastefully.

### SUMMARY OF THE INVENTION

According to a certain aspect of this invention, a projection type video display apparatus includes a light source unit that includes a plurality of single-color light sources emitting light beams of different wavelengths, a light modulation element that modulates the light beam emitted from the light source unit to form image light, based on an input video signal, a projection unit that projects the image light formed by the light modulation element, and a control unit that controls actuation of the light source unit. The control unit includes a video signal analysis unit that analyzes the video signal for each image data on a frame basis, a light emission period setting unit that sets a single-color light emission period in which at least two single-color light sources of the plurality of single-color light sources emit the light beams in a time division manner and a multiple-color light emission period in which at least two single-color light sources of the plurality of single-color light sources emit the light beams simultaneously, within one frame period, based on the result of analysis by the video signal analysis unit, and a light emission period color adjustment unit that changes a ratio between amounts of the light beams emitted from the at least two single-color light sources in the multiple-color light emission period set by the light emission period setting unit, in accordance with the result of analysis by the video signal analysis unit.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view showing an external configuration of a video display apparatus according to an embodiment of this invention.

FIG. 2 is a perspective view for illustrating an internal configuration of a projector.

FIG. 3 is a block diagram illustrating a control structure of the projector.

FIG. 4 is a graph showing display periods and gradations of an R signal, a G signal and a B signal each contained in an input image signal.

FIG. 5 is a graph illustrating a processing procedure for setting single-color light emission periods and a white light emission period in accordance with the RGB signals.

FIG. 6 is a graph showing display periods and gradations of an R signal, a G signal and a B signal each contained in an input image signal.

FIG. 7 is a graph showing single-color light emission periods and a white light emission period to be set based on the RGB signals shown in FIG. 6.

FIG. 8 is a graph showing a relation between a white light emission period and consumed electric power and efficiency in a light source device.

FIG. 9 is a graph showing a characteristic of an LED light source.

FIG. 10 is a diagram showing a configuration of a control circuit for realizing a field sequential drive method according to the embodiment.

FIG. 11 is a flowchart illustrating operations for setting R, G and B single-color light emission periods as well as a white light emission period according to the embodiment.

FIG. 12 is a graph showing display periods and gradations of an R signal, a G signal and a B signal each contained in an input image signal.

FIG. 13 is a flowchart illustrating operations for setting the white light emission period, in step S01 shown in FIG. 11.

FIG. 14 is a flowchart illustrating operations for color optimization in the white light emission period, in step S02 shown in FIG. 11.

FIG. 15 is a graph illustrating operations for Duty extension, in step S03 shown in FIG. 11.

FIG. 16 is a graph illustrating a modified example of the operations for Duty extension.

### DESCRIPTION OF THE PREFERRED EMBODIMENTS

Hereinafter, detailed description will be given of embodiments of the present invention with reference to the drawings. In the drawings, identical or corresponding portions are denoted with identical reference symbols; therefore, the description thereof will not be given repeatedly.

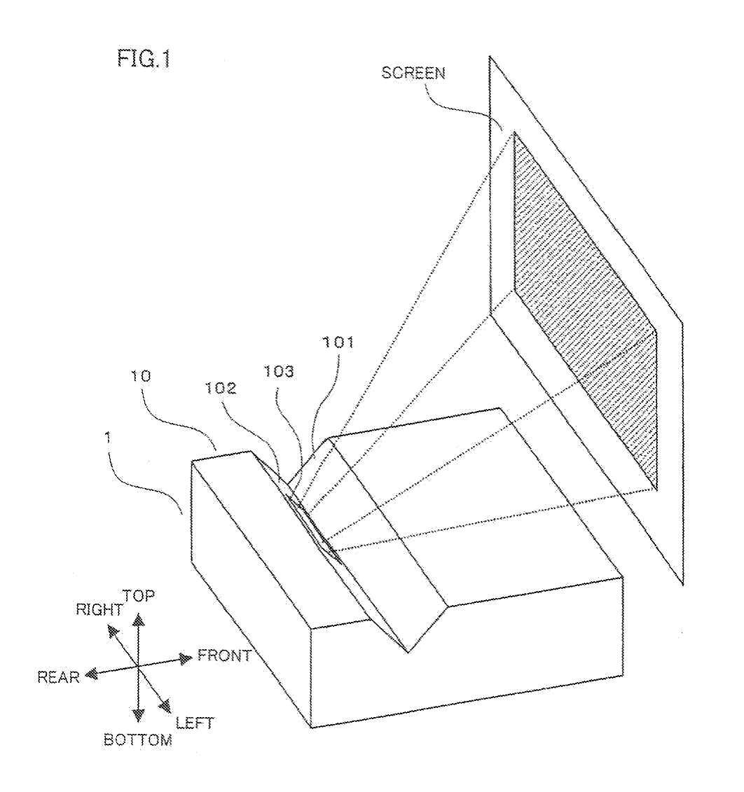

FIG. 1 is a view showing an external configuration of a video display apparatus according to an embodiment of this invention. Typically, the video display apparatus according to this embodiment is a projection type video display apparatus (hereinafter, referred to as a projector). In this embodiment, for the sake of convenience, a direction where a screen is placed when being seen from a projector 1 is defined as the front, an opposite direction to the screen is defined as the rear, a rightward direction of projector 1 which is seen from the screen is defined as the right, a leftward direction of projector 1 which is seen from the screen is defined as the left, a direction which is perpendicular to a longitudinal direction and a horizontal direction and extends from projector 1 toward the screen is defined as the top, and an opposite direction to the direction defined as the top is defined as the bottom.

Referring to FIG. 1, projector 1 is a so-called short focus projection type projector, and includes a substantially rectangular main body cabinet 10. On a top surface of main body cabinet 10, a first inclined plane 101 is formed so as to be inclined rearward, and a second inclined plane 102 is formed subsequent to first inclined plane 101 so as to be inclined rearward. Second inclined plane 102 is oriented forward in an upper slanting direction, and a projection port 103 is formed on second inclined plane 102. Video light is exited forward from projection port 103 in the upper slanting direction, and then is projected in an enlarged manner onto the screen placed forward of projector 1.

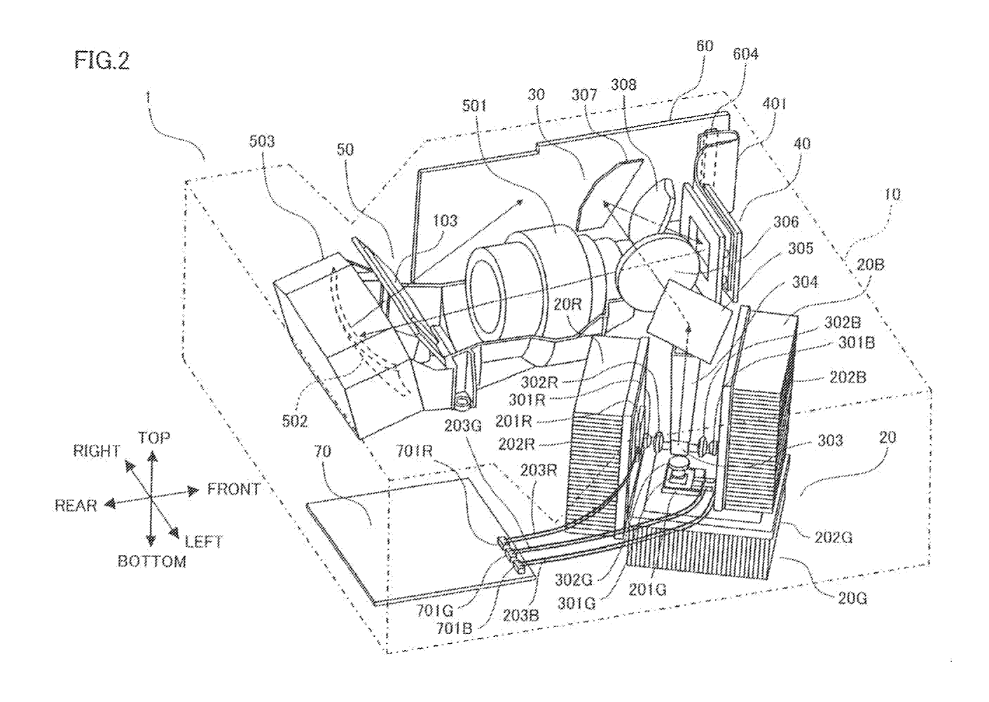

FIG. 2 is a perspective view for illustrating an internal configuration of projector 1. In FIG. 2, main body cabinet 10 is indicated by alternate long and short dashed lines for the sake of convenience.

Referring to FIG. 2, a light source device 20, a light guide optical system 30, a DMD (Digital Micromirror Device) 40, a projection optical unit 50, a control circuit 60 and an LED (Light Emitting Diode) drive circuit 70 are arranged in main body cabinet 10.

Light source device 20 includes a plurality (for example, three) of light source units 20R, 20G and 20B. Red light source unit 20R is configured with a red light source 201R that emits a light beam in a red wavelength band (hereinafter, referred to as an “R light beam”), and a heat sink 202R for releasing heat generated at red light source 201R. Green light source unit 20G is configured with a green light source 201G that emits a light beam in a green wavelength band (hereinafter, referred to as a “G light beam”), and a heat sink 202G for releasing heat generated at green light source 201G. Blue light source unit 20B is configured with a blue light source 201B that emits a light beam in a blue wavelength band (hereinafter, referred to as a “B light beam”), and a heat sink 202B for releasing heat generated at blue light source 201B. In other words, light source device 20 includes the plurality (three) of single-color light sources 201R, 201G and 201B emitting the light beams of different wavelengths.

Each of single-color light sources 201R, 201G and 201B is a high power type LED light source, and includes an LED (red LED, green LED, blue LED) mounted on a substrate. The red LED is made of, for example, AlGaInP, and each of the green LED and the blue LED is made of, for example, GaN.

Light guide optical system 30 includes first lenses 301R, 301G and 301B as well as second lenses 302R, 302G and 302B provided in correspondence with respective single-color light sources 201R, 201G and 201B, a dichroic prism 303, a hollow rod integrator (hereinafter, simply referred to as a hollow rod) 304, two mirrors 305 and 307, and two relay lenses 306 and 308.

The light beam (R light beam, G light beam, B light beam) emitted from each of single-color light sources 201R, 201G and 201B is entered into hollow rod 304. With regard to hollow rod 304, the inside is hollow and the inner side surface is formed as a mirror surface. Hollow rod 304 is formed in a tapered shape such that a cross sectional area gradually increases from an incoming end surface toward an outgoing end surface. In hollow rod 304, the light is reflected repeatedly by the mirror surface. Thus, the illumination distribution is made even at the outgoing end surface of hollow rod 304.

Herein, since hollow rod 304 is smaller in refractive index than a solid rod integrator (air refractive index <glass refractive index), the use of hollow rod 304 allows shortening of a rod length.

The light exited from hollow rod 304 is applied onto DMD 40 via the reflection by mirrors 305 and 307 and the lens action by relay lenses 306 and 308.

DMD 40 includes a plurality of micromirrors arranged in a matrix form. One micromirror forms one pixel. The micromirror is turned on and off at high speed, based on DMD drive signals corresponding to the incoming R light beam, G light beam and B light beam.

The light beam (R light beam, G light beam, B light beam) emitted from each of single-color light sources 201R, 201G and 201B is modulated by a change in inclination of the micromirror. Specifically, when a micromirror corresponding to a certain pixel is in the OFF state, light reflected from the micromirror is not entered into a lens unit 501. On the other hand, when the micromirror is in the ON state, the light reflected from the micromirror is entered into lens unit 501. The gradation of an image is adjusted for each pixel by the adjustment of an occupation ratio of a period in which the micromirror is in the ON state in a period in which the single-color light source emits a light beam.

Projection optical unit 50 is configured with lens unit 501, a curve mirror 502, and a housing 503 that holds lens unit 501 and curve mirror 502.

The light (image light) modulated by DMD 40 is exited to curve mirror 502 through lens unit 501. The image light is reflected by curve mirror 502, and is exited to the outside through projection port 103 formed on housing 503.

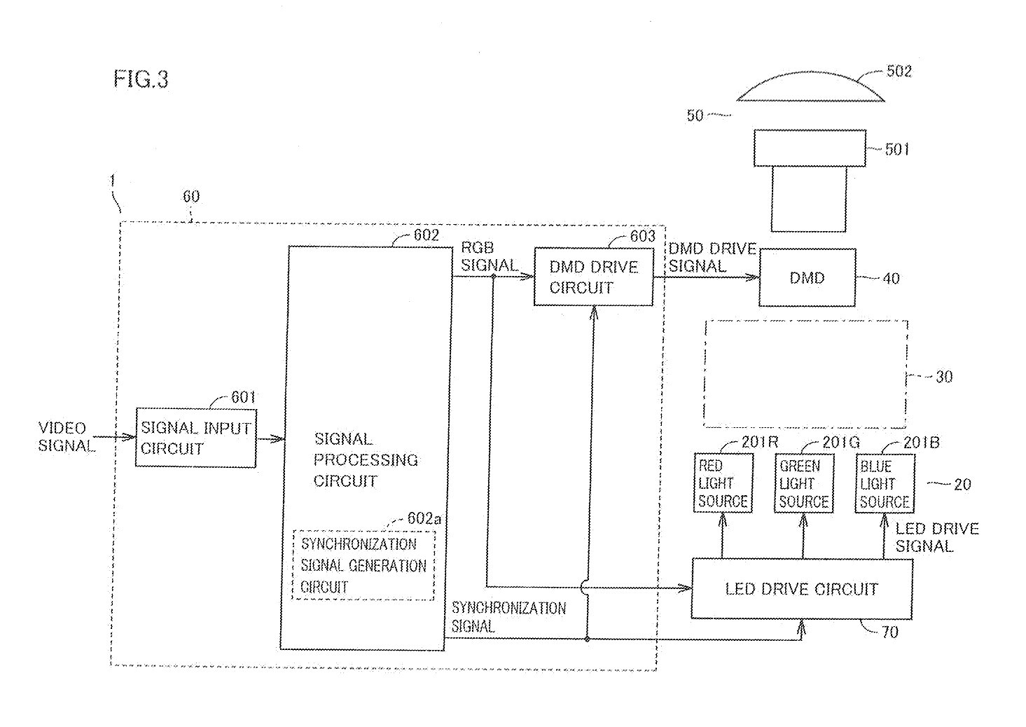

FIG. 3 is a block diagram showing a control structure in control circuit 60 of projector 1.

Referring to FIG. 3, control circuit 60 includes a signal input circuit 601, a signal processing circuit 602 and a DMD drive circuit 603.

Signal input circuit 601 receives various image signals such as a composite signal as well as RGB signals through various input terminals corresponding to these image signals, and then outputs the image signals to signal processing circuit 602.

Signal processing circuit 602 performs a process of converting image signals other than RGB signals into RGB signals, a scaling process of converting a resolution of an input image signal into a resolution for DMD 40, or various correcting processes such as gamma correction.

Further, signal processing circuit 602 extracts white components from the RGB signals subjected to these processes, and converts the RGB signals into the time-reduced RGB signals as well as white components, based on the extracted white components. Then, signal processing circuit 602 outputs the converted RGB signals as well as white components to DMD drive circuit 603 and LED drive circuit 70.

Signal processing circuit 602 includes a synchronization signal generation circuit 602a. Synchronization signal generation circuit 602a generates a synchronization signal for synchronizing actuation of each of single-color light sources 201R, 201G and 201B with actuation of DMD 40. The generated synchronization signal is output to DMD drive circuit 603 and LED drive circuit 70.

DMD drive circuit 603 generates DMD drive signals (ON and OFF signals) corresponding to the R light beam, G light beam and B light beam, based on the RGB signals from signal processing circuit 602. Then, DMD drive circuit 603 outputs the generated DMD drive signals corresponding to the respective color light beams sequentially to DMD 40 for each image in one frame in a time division manner, in accordance with the synchronization signal.

LED drive circuit 70 drives single-color light sources 201R, 201G and 201B, based on the RGB signals from signal processing circuit 602. Specifically, LED drive circuit 70 generates an LED drive signal by a pulse width modulation (PWM) method, and outputs the generated LED drive signal (drive current) to each of single-color light sources 201R, 201G and 201B.

That is, LED drive circuit 70 adjusts amounts of light beams to be emitted from respective single-color light sources 201R, 201G and 201B by adjusting a duty ratio of pulse waves, based on RGB signals. Thus, the amounts of light beams to be emitted from respective single-color light sources 201R, 201G and 201B are adjusted for each image in one frame, in accordance with color information of the image.

Moreover, LED drive circuit 70 outputs the LED drive signal to each of single-color light sources 201R, 201G and 201B in accordance with the synchronization signal. Thus, it is possible to synchronize a light emission timing that single-color light sources 201R, 201G and 201B emit light beams (R light beam, G light beam, B light beam) with a timing that DMD 40 receives a DMD drive signal corresponding to each light beam.

More specifically, in the period of output of the DMD drive signal corresponding to the R light beam, red light source 201R emits the R light beam in an amount suitable for color information of an image at this timing. Likewise, in the period of output of the DMD drive signal corresponding to the G light beam, green light source 201G emits the G light beam in an amount suitable for color information of an image at this timing. Further, in the period of output of the DMD drive signal corresponding to the B light beam, blue light source 201B emits the B light beam in an amount suitable for color information of an image at this timing.

As described above, it is possible to enhance the brightness of a projected image while suppressing electric power consumption, by changing the amount of the light beam to be emitted from each of single-color light sources 201R, 201G and 201B in accordance with color information of the image.

Herein, images based on the R light beam, G light beam and B light beam are projected sequentially onto the screen. However, since these images are switched at considerably high speed, a user can see a flicker-free color image.

As described above, with regard to the field sequential drive type projector in which the plurality of single-color light sources 201R, 201G and 201B emit light beams sequentially in a time division manner, the following configuration has been taken into consideration from the viewpoint of improvement in brightness of a projected image. That is, a period in which at least two of single-color light sources 201R, 201G and 201B are driven simultaneously to emit a white light beam (hereinafter, referred to as a “white light emission period”) is added to a period in which each single-color light source emits a light beam individually (hereinafter, referred to as a “single-color light emission period”), within a frame period for displaying an image in one frame.

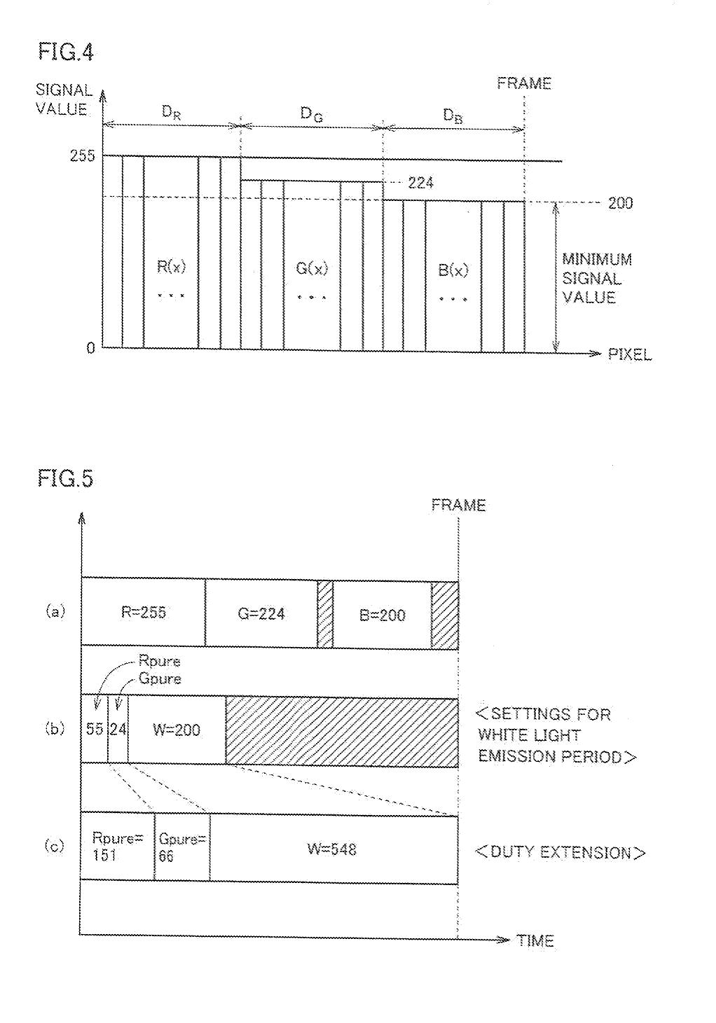

With reference to FIGS. 4 and 5, hereinafter, description will be given of a conventional field sequential drive method for improving the brightness of a projected image by addition of such a white light emission period.

### (Conventional Field Sequential Drive Method)

FIG. 4 is a graph showing display periods and gradations of an R signal, a G signal and a B signal each contained in an input image signal. The input image signal indicates gradations in red, green and blue to be displayed for each pixel which forms one image area. It is assumed in FIG. 4 that the input image signal is 8-bit image data per one pixel. Accordingly, the input image signal has a 256-step gradation in which the minimum value is “0” and the maximum value is “255”.

In FIG. 4, R(x), G(x) and B(x) denote signal values (gradation values) of the R signal, G signal and B signal. It is assumed in FIG. 4 that the pixels which form one image area each have the identical signal values (R(x)=255, G(x)=224, B(x)=200). Also in FIG. 4, DR, DG and DB denote display periods of the R signal, G signal and B signal in the sequential drive method.

FIG. 5 is a graph illustrating a processing procedure for setting the single-color light emission periods and the white light emission period in accordance with the RGB signals.

In FIG. 5, (a) shows the light emission periods in which single-color light sources 201R, 201G and 201B emit light beams for displaying the R signal. G signal and B signal shown in FIG. 4. In R light emission period R in which red light source 201R emits the light beam, B light emission period B in which blue light source 201B emits the light beam and G light emission period G in which green light source 201G emits the light beam, the minimum value is set at “0” and the maximum value is set at “255” in correspondence with the 256-step gradation of the R signal, G signal and B signal. When the respective light emission periods are adjusted in accordance with the RGB signals, the amounts of light beams to be emitted from single-color light sources 201R, 201G and 201B are adjusted for each image in one frame. For example, when the R signal of each pixel has a maximum value Rmax of “255”, the maximum value of “255” is set in the R light emission period. In the example shown in FIG. 4, since maximum values Rmax, Gmax and Bmax of the R signal, G signal and B signal are “255”, “224” and “200”, the values in R light emission period R, G light emission period G and B light emission period B are set at “255”, “224” and “200”.

Next, a white component is extracted from each of the RGB signals. The white component is extracted with the minimum signal values of the RGB signals as a basis. This minimum signal value is the minimum one of signal values R(x), G(x) and B(x). In the example shown in FIG. 4, the minimum signal value is signal value B(x) of “200”. The value of “200” is set in white light emission period W in which single-color light sources 201R, 201G and 201B are driven simultaneously in order to display the extracted white components.

By the extraction of the white components from the RGB signals, R light emission period R, G light emission period G and B light emission period B are adjusted to the periods from which white light emission period W is subtracted, respectively. Herein, adjusted single-color light emission periods R, G and B are referred to as an R single-color light emission period Rpure, a G single-color light emission period Gpure and a B single-color light emission period Bpure. R single-color light emission period Rpure, G single-color light emission period Gpure and B single-color light emission period Bpure are calculated from the following expression (1), respectively.

Rₚᵤᵣₑ=R−W

Gₚᵤᵣₑ=G−W

Bₚᵤᵣₑ=B−W (1)

In accordance with the foregoing expression (1), the values of “55”, “24” and “0” in R single-color light emission period Rpure, G single-color light emission period Gpure and B single-color light emission period Bpure are obtained by subtraction of the value of “200” in white light emission period W from each of the values of “255”, “224” and “200” in R light emission period R, G light emission period G and B light emission period B shown in (a) of FIG. 5.

Next, the R, G and B components as well as the white components are relocated. As shown in (b) of FIG. 5, this relocation is to devise a primary combination such that R single-color light emission period Rpure, G single-color light emission period Gpure, B single-color light emission period Bpure and white light emission period W do not overlap. In the case of relocation of the R, G and B components as well as the white component, the position of the white component is not particularly limited.

Also in FIG. 5, (c) shows scaling to be performed on the display periods of the R, G and B components as well as white component, in accordance with one frame period. In the primary combination to be obtained from the relocation of the R, G and B components as well as white component shown in (b) of FIG. 5, the sum total of R, G and B single-color light emission periods Rpure, Gpure and Bpure as well as white light emission period W does not match with the frame period. Accordingly, it is necessary to perform scaling such that the sum total matches with the frame period by adjusting the R G and B single-color light emission periods as well as white light emission period. This temporal scaling is performed by extending each of the R, G and B single-color light emission periods as well as white light emission period at an identical ratio.

Specifically, LED drive circuit 70 increases duties of pulse waves to be output as LED drive signals to single-color light sources 201R, 201G and 201B at the identical ratio. Hereinafter, the extension of each single-color light emission period and the white light emission period will be referred to as “Duty extension” and a ratio of the Duty extension will be referred to as a “Duty extending ratio”.

Herein, Duty extending ratio DER corresponds to the inverse of an occupation ratio of the sum total of R, G and B single-color light emission periods Rpure, Gpure and Bpure as well as white light emission period W in the frame period, and is calculated from the following expression (2).

$$D E R = \frac{255 + 255 + 255}{{R}_{pure} + {G}_{pure} + {B}_{pure} + W} \qquad ( 2 )$$

The Duty extending ratio (DER=765/279) is derived by substitution of the values in the single-color light emission periods (Rpure, Gpure, Bpure=55, 24, 0) and white light emission period (W=200) shown in (b) of FIG. 5 into the foregoing expression (2). Each single-color light emission period and the white light emission period are subjected to scaling using the calculated Duty extending ratio and, as the result, are extended (Rpure=151, Gpure=66, Bpure=0, W=548).

As described above, the white component is extracted from the input image signal, and the white light emission period is provided for displaying the extracted white component. Thus, temporal constraints concerning the light emission period are eliminated at the time of sequentially driving the single-color light sources. As the result, it is possible to improve the brightness of a projected image.

### (Relation Between Length of White Light Emission Period and Efficiency of Light Source Device)

With reference to the drawings, hereinafter, description will be given of a relation between a length of a white light emission period and efficiency of each single-color light source.

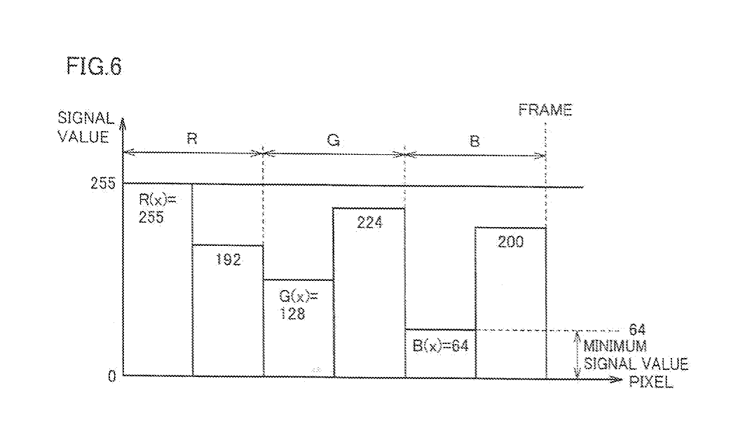

FIG. 6 is a graph showing display periods and gradations of an R signal, a G signal and a B signal each contained in an input image signal. It is assumed in FIG. 6 that one image area is configured with a group of pixels each having signal values (R(x), G(x), B(x)=255, 128, 64) and a group of pixels each having signal values (192, 224, 200).

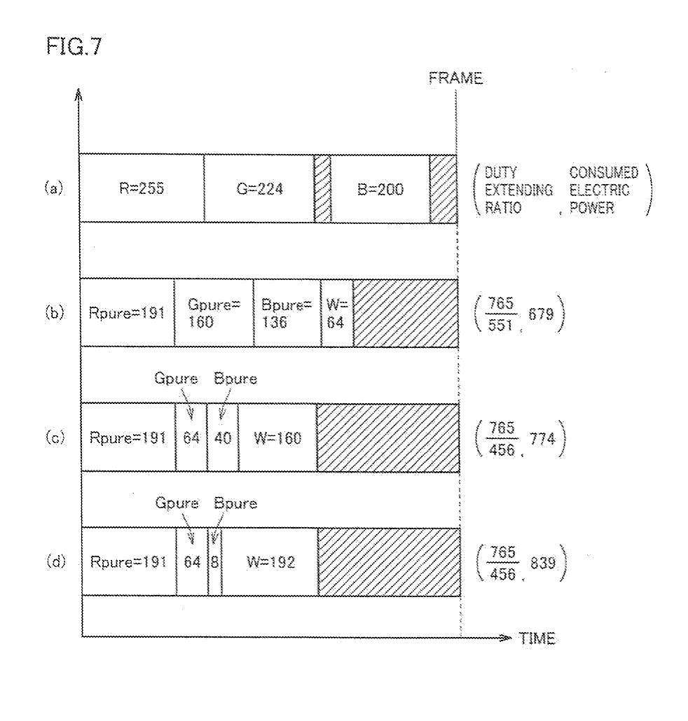

FIG. 7 is a graph showing single-color light emission periods and a white light emission period to be set based on the RGB signals shown in FIG. 6.

In FIG. 7, (a) shows the R light emission period, G light emission period and B light emission period for displaying the RGB signals shown in FIG. 6. In the example shown in FIG. 6, the R signal, G signal and B signal of each pixel have maximum values (Rmax, Gmax, Bmax=255, 224, 200). Therefore, the values of “255”, “224” and “200” are set in R light emission period R, G light emission period G and B light emission period B.

Also in FIG. 7, (b), (c) and (d) each show an example of a combination of R, G and B single-color light emission periods Rpure, Gpure and Bpure as well as white light emission period W adjusted based on the white components in the RGB signals shown in FIG. 6.

The combination example shown in (b) of FIG. 7 is the combination of the R, G and B single-color light emission periods as well as white light emission period adjusted in such a manner that attention is given to the R signal among the RGB signals shown in FIG. 6. Specifically, the minimum one of the signal values of the RGB signals of each pixel is extracted as the white component, and the extracted white component is subtracted from signal value R(x) of the R signal, so that the R component in the relevant pixel is calculated. For example, with regard to the pixel having the signal values (R(x), G(x), B(x)=255, 128, 64), since the white component takes signal value B(x) of “64”, the R component takes the value of “191” obtained by subtracting “64” from “225”. As in the similar manner, the R component of each pixel is calculated in an image in one frame, and a display period for displaying the maximum value among the calculated R components of all the pixels is set at R single-color light emission period Rpure. Then, white light emission period W is calculated by subtraction of the value in R single-color light emission period Rpure from maximum value Rmax of the R signal of each pixel. In FIG. 6, since maximum value Rmax is “255” and the value in R single-color light emission period Rpure is “191” the value in white light emission period W is “64”.

The combination example shown in (c) of FIG. 7 is the combination of the R, G and B single-color light emission periods as well as white light emission period adjusted in such a manner that attention is given to the G signal among the RGB signals shown in FIG. 6. Specifically, the minimum one of the signal values of the RGB signals of each pixel is extracted as the white component, and the extracted white component is subtracted from signal value G(x) of the G signal, so that the G component in the relevant pixel is calculated. For example, with regard to the pixel having the signal values (R(x), G(x), B(x)=255, 128, 64), since the white component takes signal value B(x) of “64”, the G component takes the value of “64” obtained by subtracting “64” from “128”. As in the similar manner, the G component of each pixel is calculated in an image in one frame, and a display period for displaying the maximum value among the calculated G components of all the pixels is set at G single-color light emission period Gpure. Finally, white light emission period W is calculated by subtraction of the value in G single-color light emission period Gpure from maximum value Gmax of the G signal of each pixel. In FIG. 6, since maximum value Gmax is “224” and the value in G single-color light emission period Gpure is “64”, the value in white light emission period W is “160”.

The combination example shown in (d) of FIG. 7 is the combination of the single-color light emission periods as well as white light emission period adjusted in such a manner that attention is given to the B signal among the RGB signals shown in FIG. 6. Specifically, the minimum one of the signal values of the RGB signals of each pixel is extracted as the white component, and the extracted white component is subtracted from signal value B(x) of the B signal, so that the B component in the relevant pixel is calculated. For example, with regard to the pixel having the signal values (R(x), G(x), B(x)=255, 128, 64), since the white component takes signal value B(x) of “64”, the B component takes the value of “0” obtained by subtracting “64” from “64”. As in the similar manner, the B component of each pixel is calculated in an image in one frame, and a display period for displaying the maximum value among the calculated B components of all the pixels is set at B single-color light emission period Bpure. Finally, white light emission period W is calculated by subtraction of the value in B single-color light emission period Bpure from maximum value Bmax of the B signal of each pixel. In FIG. 6, since maximum value Bmax is “200” and the value in B single-color light emission period Bpure is “8”, the value in white light emission period W is “192”.

It is apparent from a comparison to be performed on the combination examples shown in (b), (c) and (d) of FIG. 7 that the sum total of the R, G and B single-color light emission periods Rpure, Gpure and Bpure as well as white light emission period W differs in accordance with the length of white light emission period W, although these periods are set based on the common input image signal. Specifically, the sum total decreases as white light emission period W is extended. As the result, the Duty extending ratio to be determined from the ratio between the sum total and the frame period increases as white light emission period W is extended. Herein, it is possible to improve the brightness of a projected image by the extension of the Duty extending ratio.

On the other hand, electric power to be consumed by light source device 20 varies in accordance with the length of white light emission period W. The electric power to be consumed by light source device 20 corresponds to a total of electric power to be consumed by red light source 201R, electric power to be consumed by green light source 201G and electric power to be consumed by blue light source 201B. A total value of this electric power consumption is substantially proportional to the total value in the light emission periods of red light source 201R, blue light source 201B and green light source 201G, and therefore is specified with the total value in the light emission periods of the respective single-color light sources, in FIG. 7.

In the case shown in (b) of FIG. 7, for example, the value in R light emission period R is “255” (=191+64), the value in G light emission period G is “224” (=160+64), and the value in B light emission period B is “200” (=136+64). Therefore, the value of electric power consumption is specified at “679” which is the sum of these values. In contrast to this, in the case shown in (c) of FIG. 7, the value in R light emission period R is “351” (=191+160), the value in G light emission period G is “224” (=64+160), and the value in B light emission period B is “200” (=40+160). Therefore, the value of electric power consumption is specified at “774”. Likewise, in the case shown in (d) of FIG. 7, the value of electric power consumption is specified at “839”.

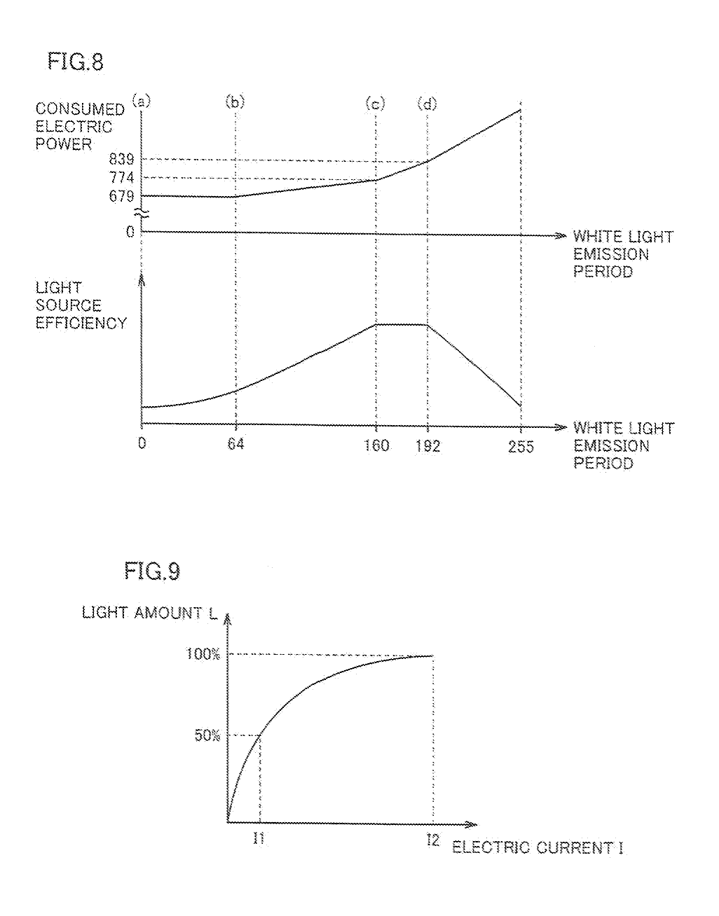

FIG. 8 is a graph showing a relation between the white light emission period and the consumed electric power and efficiency in the light source device. In the graph shown in FIG. 8, a horizontal axis indicates the value in the white light emission period and a longitudinal axis indicates the values of the consumed electric power and efficiency in light source device 20. The relation is shown in such a manner that the value in the white light emission period is plotted on the horizontal axis and the values of the consumed electric power and efficiency in light source device 20 are each plotted on the longitudinal axis, for each of the combinations shown in (a) to (d) of FIG. 7.

In FIG. 8, the efficiency of light source device 20 is calculated, in a configuration that the single-color light source (red light source 201R, green light source 201G, blue light source 201B) is an LED light source, based on a characteristic of a light emission amount relative to a drive current in each LED light source. Specifically, an LED light source typically has a relation between a drive current and a light emission amount as shown in FIG. 9. In FIG. 9, a light emission amount relative to a drive current I is shown with a light emission amount in a case of a drive current I2 in the LED light source defined as 100%.

Referring to FIG. 9, the LED light source has a characteristic that light emission efficiency indicating a ratio of a light emission amount to consumed electric power is reduced as a drive current becomes large, for the following reason. That is, in a case where an element temperature rises because of heat to be generated from an element itself when a current amount increases, the light emission amount in the LED light source is reduced. In other words, the light emission efficiency is enhanced as the drive current becomes small.

It is assumed herein that the LED light source emits a light beam in an amount of 100% during a predetermined period and emits a light beam in an amount of 50% during a period which is twice as large as the predetermined period, based on the characteristic of the LED light source. The light emission amounts in the two cases are equal to each other; however, the light emission efficiency in the latter case is higher than that in the former case. Therefore, the electric power consumption can be suppressed. This fact is applied to the combinations shown in (a) to (d) of FIG. 7. As the Duty extending ratio becomes large, the R, G and B single-color light emission periods as well as white light emission period are extended to be longer. Therefore, in the case of achieving a constant light emission amount, the light emission efficiency of light source device 20 is enhanced as the Duty extending ratio becomes large, which is effective for improvement in efficiency.

As described above, the light emission efficiency of each single-color light source is enhanced although the light emission period of each single-color light source increases by the extension of the white light emission period. As the result, it is possible to suppress the electric power consumption in the light source device white keeping the brightness of a projected image.

However, the light emission periods of single-color light sources 201R, 201G and 201B are extended uniformly based on the Duty extending ratio by the extension of the white light emission period. Consequently, there may arise a possibility that any of single-color light sources 201R, 201G and 201B emits a light beam in an amount exceeding an amount required for displaying corresponding one of the RGB signals. As the result, there arises a disadvantage that the single-color light source consumes electric power wastefully although the efficiency of the light source device is enhanced by the extension of the white light emission period.

In the example shown in FIG. 7, for example, the values in R light emission period R, G light emission period G and B light emission period B are set at “255”, “224” and “200”, based on the maximum values (Rmax, Gmax, Bmax=255, 224, 200) of the R signal, G signal and B signal ((a) of FIG. 7). In contrast to this, in the case where the value in white light emission period W is set at “64” ((b) of FIG. 7), the value in R light emission period R is set at “255” (=191+64), the value in G light emission period G is set at “224” (=160+64), and the value in B light emission period B is set at “200” (=136+64). These values match with those set based on the maximum signal values of the RGB signals in the light emission periods. Accordingly, none of single-color light sources 201R, 201G and 201B consumes electric power wastefully.

In contrast to this, in the case where the value in white light emission period W is “160” ((c) of FIG. 7), the value in R light emission period R is “351” (=191+160) exceeding “255” which is the value set based on maximum value Rmax of the R signal in R light emission period R. Accordingly, red light source 201R emits a light beam in an amount exceeding an amount required for displaying the R signal, and consumes electric power wastefully.

Further, in the case where the value in white light emission period W is “192” ((d) of FIG. 7), the value in R light emission period R is “383” (=191+192) exceeding “255” which is the value set based on maximum value Rmax of the R signal in R light emission period R. Further, the value in G light emission period G is “256” (=64+192) exceeding “224” which is the value set based on maximum value Gmax of the G signal in G light emission period G. Accordingly, each of red light source 201R and green light source 201G consumes electric power excessively.

In order to suppress the wasteful electric power consumption, it is effective to reduce an amount of a light beam to be emitted from the single-color light source which consumes electric power wastefully, in the white light emission period, for the following reason. That is, since R single-color light emission period Rpure, G single-color light emission period Gpure and B single-color light emission period Bpure are periods to be required for displaying R, G and B components of each pixel. Consequently, when the amount of the light beam to be emitted from each single-color light source is reduced during such a period, the color saturation of a projected image is reduced, which is not preferable.

In the field sequential drive method according to this embodiment, accordingly, the wasteful electric power consumption is suppressed by reducing the amounts of light beams to be emitted from single-color light sources 201R, 201G and 201B in the white light emission period. On the other hand, the reduction in amounts of light beams to be emitted from single-color light sources 201R, 201G and 201B in the white light emission period causes variations in hue and color saturation of a light beam to be emitted from light source device 20 in the white light emission period. Consequently, there arises a possibility that the lack in color balance occurs at some images.

In order to prevent such a possibility, according to this embodiment, the ratio of the R, G and B components in the white light emission period is changed in accordance with the RGB signals such that all the pixels which form one image area can be displayed without color collapse. Then, the brightness in each single-color light source in the white color light emission period is adjusted in accordance with the ratio of the R, G and B components adapted to the RGB signals. As described above, the brightness in each of single-color light sources 201R, 201G and 201B in the white light emission period is adjusted to a requisite minimum brightness so as not to cause color collapse of a projected image, so that the amounts of light beams to be emitted from single-color light sources 201R, 201G and 201B in the white light emission period can be reduced to such a degree that the color reproducibility of a projected image is not impaired. As the result, it is possible to suppress the electric power consumption by the light source device.

With reference to the drawings, hereinafter, description will be given of the field sequential drive method according to this embodiment.

(Field Sequential Drive Method According to this Embodiment)

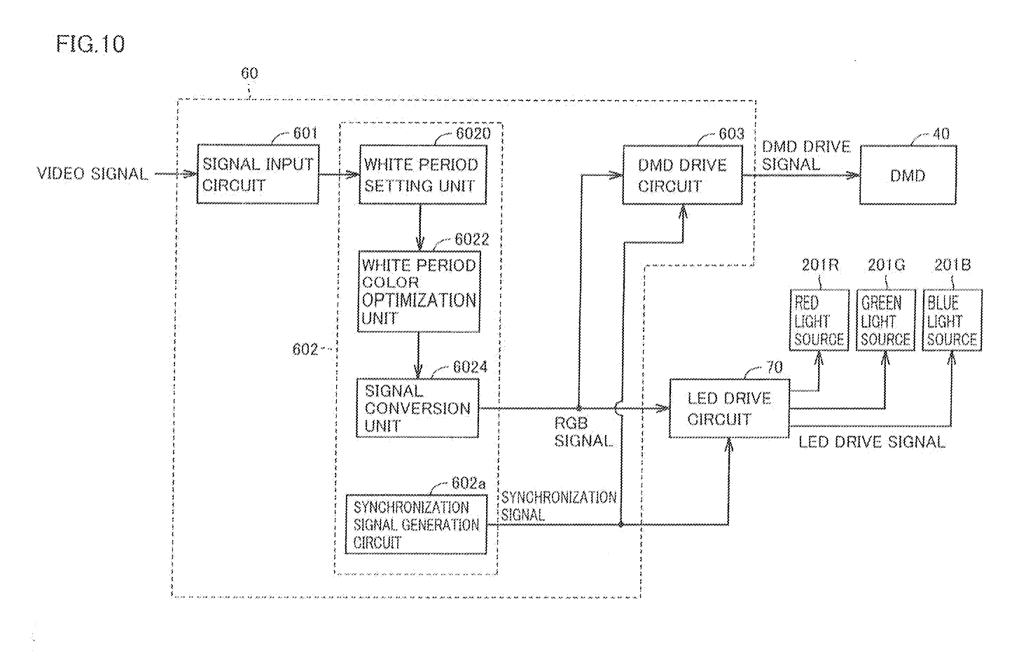

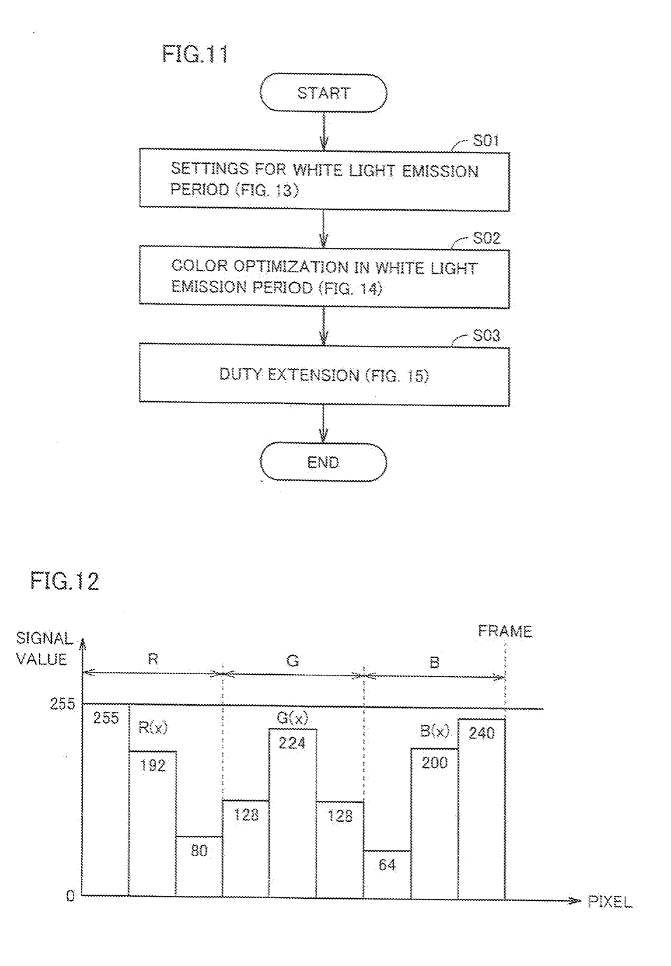

FIG. 10 is a diagram showing a configuration of a control circuit for realizing the field sequential drive method according to this embodiment.

Referring to FIG. 10, a control circuit 60 includes a signal input circuit 601, a signal processing circuit 602 and a DMD drive circuit 603.

Signal input circuit 601 receives a video signal through an input terminal, and then outputs the video signal to signal processing circuit 602.

Signal processing circuit 602 includes a white period setting unit 6020, a white period color optimization unit 6022, a signal conversion unit 6024 and a synchronization signal generation circuit 602a.

White period setting unit 6020 sets an R single-color light emission period Rpure, a G single-color light emission period Gpure, a B single-color light emission period Bpure and a white light emission period W for each image in one frame, based on RGB signals generated by conversion of an input image signal.

White period color optimization unit 6022 performs a brightness adjustment on red light source 201R, green light source 201G and blue light source 201B in white light emission period W set by white period setting unit 6020. Herein, on condition that all pixels which form one image area have no color deviation to an input image signal, the brightness in each of single-color light sources 201R, 201G and 201B is adjusted based on a ratio of R, G and B components in white light emission period W so as to satisfy the condition.

Signal conversion unit 6024 relocates the R, G and B components as well as white components, and performs scaling on display periods of the R, G and B components as well as white component in accordance with one frame period. Specifically, signal conversion unit 6024 performs the relocation such that white light emission period W in which white period color optimization unit 6022 performs the brightness adjustment on the respective single-color light sources does not overlap R, G and B single-color light emission periods Rpure, Gpure and Bpure to devise a primary combination. Then, signal conversion unit 6024 extends the R, G and B single-color light emission periods as well as white light emission period at an identical ratio (Duty extending ratio) such that a sum total of the R, G and B single-color light emission periods as well as white light emission period, based on this combination, matches with the frame period. Signal conversion unit 6024 generates signals indicating the R, G and B single-color light emission periods as well as white light emission period each subjected to the scaling, and then outputs these signals to DMD drive circuit 603 and LED drive circuit 70.

Synchronization signal generation circuit 602a generates a synchronization signal for synchronizing actuation of each of single-color light sources 201R, 201G and 201B with actuation of DMD 40. The generated synchronization signal is output to DMD drive circuit 603 and LED drive circuit 70.

DMD drive circuit 603 generates DMD drive signals corresponding to an R light beam, a G light beam and a B light beam, based on RGB signals. Then, DMD drive circuit 603 outputs the generated DMD drive signals corresponding to the respective light beams sequentially to DMD 40 in a time division manner for each image in one frame, in accordance with the synchronization signal.

LED drive circuit 70 generates LED drive signals corresponding to the respective single-color light sources by a PWM method, based on the signals indicating the R, G and B single-color light emission periods as well as white light emission period from signal conversion unit 6024. Then, LED drive circuit 70 outputs the generated LED drive signals corresponding to the respective single-color light sources to single-color light sources 201R, 201G and 201B in accordance with the synchronization signal. In other words, LED drive circuit 70 adjusts amounts of light beams to be emitted from single-color light sources 201R, 201G and 201B by adjusting a duty ratio of pulse waves in accordance with the signals from signal conversion unit 6024. Thus, the amounts of light beams to be emitted from single-color light sources 201R, 201G and 201B are adjusted for each image in one frame, in accordance with color information of the image.

Moreover, LED drive circuit 70 outputs the LED drive signals to the respective single-color light sources in accordance with the synchronization signal to synchronize a timing that single-color light sources 201R, 201G and 201B emit light beams (R light beam, G light beam, B light beam) with a timing that DMD 40 receives the DMD drive signal corresponding to each light beam.

More specifically, in R single-color light emission period Rpure, DMD 40 receives a DMD drive signal which is generated based on an R component in an image at this timing and corresponds to an R light beam. Likewise, in G single-color light emission period Gpure, DMD 40 receives a DMD drive signal which is generated based on a G component in an image at this timing and corresponds to a G light beam. Moreover, in B single-color light emission period Bpure, DMD 40 receives a DMD drive signal which is generated based on a B component in an image at this timing and corresponds to a B light beam. Further, in white light emission period W, DMD 40 receives DMD signals which are generated based on a white component in an image at this timing and correspond to the R light beam, G light beam and B light beam.

It is possible to suppress electric power consumption by the light source device without lacking the color balance of a projected image, by changing lengths of the R, G and B single-color light emission periods as well as white light emission period in accordance with color information of the image and changing a ratio of R, G and B components in the white light emission period.

FIG. 11 is a flowchart illustrating operations for setting the R, G and B single-color light emission periods as well as white light emission period according to this embodiment. Herein, processes in steps shown in FIG. 11 are realized in such a manner that control circuit 60 functions as the respective control blocks shown in FIG. 10.

Referring to FIG. 11, white period setting unit 6020 sets an R single-color light emission period Rpure, a G single-color light emission period Gpure, a B single-color light emission period Bpure and a white light emission period W for each image in one frame, based on RGB signals generated by conversion of an input image signal (step S01).

Next, white period color optimization unit 6022 performs a brightness adjustment on red light source 201R, green light source 201G and blue light source 201B in white light emission period W set by white period setting unit 6020 (step S02).

Next, signal conversion unit 6024 relocates white light emission period W in which white period color optimization unit 6022 performs the brightness adjustment on the respective single-color light sources as well as R, G and B single-color light emission periods Rpure, Gpure and Bpure such that these periods do not overlap, and then performs scaling (Duty extension) on the R, G and B single-color light emission periods as well as white light emission period in accordance with one frame period (step S03).

With reference to the drawings, hereinafter, detailed description will be given of the processes in steps S01, S02 and S03 shown in FIG. 11.

### (Settings for White Light Emission Period)

FIG. 12 is a graph showing display periods and gradations of the R signal, G signal and B signal contained in the input image signal. It is assumed in FIG. 12 that one image area is configured with a group of pixels each having signal values (R(x), G(x), B(x)=255, 128, 64), a group of pixels each having signal values (192, 224, 200), and a group of pixels each having signal values (80, 128 and 240).

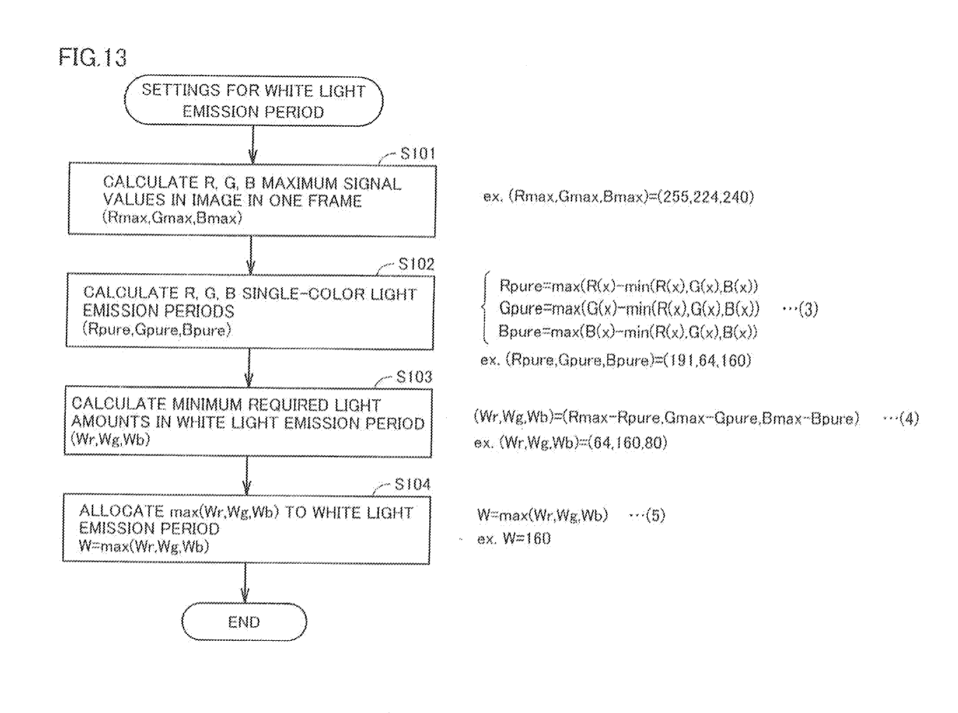

FIG. 13 is a flowchart illustrating the operations for setting the white light emission period in step S01 shown in FIG. 11.

Referring to FIG. 13, first, white period setting unit 6020 calculates maximum values Rmax, Gmax and Bmax of RGB signals which form an image in one frame (step S101). In the example shown in FIG. 12, maximum values Rmax, Gmax and Bmax are “255”, “224” and “240”.

Next, white period setting unit 6020 extracts white components from RGB signals of each pixel, and calculates R, G and B single-color light emission periods, based on the extracted white components. Specifically, a minimum signal value min(R(x),G(x),B(x)) among the RGB signals of each pixel is extracted as the white component. An R component of the relevant pixel is calculated by subtraction of the extracted white component from signal value R(x) of the R signal. In the example shown in FIG. 12, with regard to the pixel having the signal values (R(x), G(x), B(x)=255, 128, 64), since the white component takes signal value B(x) of “64”, the R component takes the value of “191” obtained by subtracting “64” from “255”. Likewise, with regard to the pixel having the signal values (192, 224, 200), since the white component takes signal value R(x) of “192”, the R component takes the value of “0” obtained by subtracting “192” from “192”. Moreover, with regard to the pixel having the signal values (80, 128, 240), since the white component takes signal value R(x) of “80”, the R component takes the value of “0” obtained by subtracting “80” from “80”.

When the R component of each pixel is calculated, then, white period setting unit 6020 sets the display period for displaying the maximum value among the calculated R components of all the pixels at an R single-color light emission period Rpure, in accordance with the following expression (3). In the case described above, the value in R single-color light emission period Rpure is set at the maximum value of “191”.

Likewise, white period setting unit 6020 calculates the G component of each pixel, and sets the display period for displaying the maximum value among the calculated G components of all the pixels at a G single-color light emission period Gpure, in accordance with the following expression (3). Moreover, white period setting unit 6020 calculates the B component of each pixel, and sets the display period for displaying the maximum value among the calculated B components of all the pixels at a B single-color light emission period Bpure, in accordance with the following expression (3). In the example shown in FIG. 12, the values of “191”, “64” and “160” are set in R, G and B single-color light emission periods Rpure, Gpure and Bpure.

Rₚᵤᵣₑ=max(R(x)−min(R(x),G(x),B(x)))

Gₚᵤᵣₑ=max(G(x)−min(R(x),G(x),B(x)))

Bₚᵤᵣₑ=max(B(x)−min(R(x),G(x),B(x))) (3)

Next, white period setting unit 6020 calculates minimum required light amounts, that is, minimum amounts of an R light beam, a G light beam and a B light beam required for displaying the white component in the white light emission period, based on maximum values Rmax, Gmax and Bmax of the RGB signals as well as the values in R, G and B single-color light emission periods Rpure, Gpure and Bpure corresponding to the maximum values of the R, G and B components of each pixel (step S103).

Specifically, in the white light emission period, minimum required light amount Wr of the R light beam is acquired by subtraction of the value in R single-color light emission period Rpure from maximum value Rmax of the R signal, in accordance with the following expression (4). Likewise, minimum required light amount Wg of the G light beam is acquired by subtraction of the value in G single-color light emission period Gpure from maximum value Gmax of the G signal. Moreover, minimum required light amount Wb of the B light beam is acquired by subtraction of the value in B single-color light emission period Bpure from maximum value Bmax of the B signal. In the case of the RGB signals shown in FIG. 12, maximum values Rmax, Gmax and Bmax are “255”, “224” and “240”, and the values in R, G and B single-color light emission periods Rpure, Gpure and Bpure are “191”, “64” and “160”. Therefore, minimum required light amounts Wr, Wg and Wb of the R, G and B light beams take the values of “64”, “160” and “80”.

(Wᵣ,W_{g},W_{b})=(Rₘₐₓ−Rₚᵤᵣₑ,Gₘₐₓ−Gₚᵤᵣₑ,Bₘₐₓ−Bₚᵤᵣₑ) (4)

Next, white period setting unit 6020 sets white light emission period W, based on minimum required light amounts Wr, Wg and Wb of the R, G and B light beams, calculated in step S103, in the white light emission period (step S104). Specifically, white period setting unit 6020 allocates the maximum value among the minimum required light amounts of the R, G and B light beams to the value in white light emission period W, in accordance with the following expression (5). In the case of the RGB signals shown in FIG. 12, the value of “160” which is the value of minimum required light amount Wg corresponds to the maximum value and is allocated to the value in white light emission period W.

W=max(Wᵣ,W_{g},W_{b}) (5)

As described above, each single-color light source configured with an LED light source can be driven with a small electric current by the extension of white light emission period W, so that each single-color light source is improved in light emission efficiency. Therefore, white period setting unit 6020 allocates the maximum value among of minimum required light amounts Wr, Wg and Wb of the R, G and B light beams to the value in white light emission period W to achieve the suppression of electric power consumption by the light source device.

### (Color Optimization in White Light Emission Period)

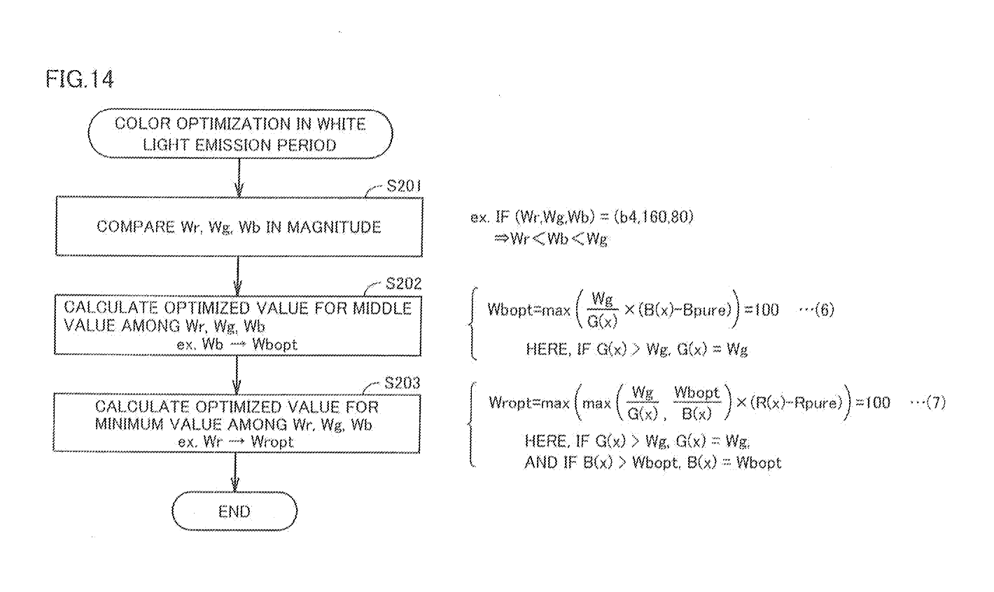

As described above, when white period setting unit 6020 allocates the maximum value of “160” among minimum required light amounts Wr, Wg, and Wb of the R, G and B light beams, that is, the value of minimum required light amount Wg to the value in white light emission period W, with regard to red light source 201R, the sum total of the value in R single-color light emission period Rpure and the value in white light emission period W exceeds the value of “255” which is set in R light emission period R, based on maximum value Rmax of the R signal. With regard to blue light source 201B, moreover, the sum total of the value in B single-color light emission period Bpure and the value in white light emission period W exceeds the value of “240” which is set in B light emission period B, based on maximum value Bmax of the B signal. Accordingly, each of red light source 201R and blue light source 201B consumes electric power excessively. Herein, white period color optimization unit 6022 performs processes shown in FIG. 14 to reduce the amounts of light beams to be emitted from red light source 201R and blue light source 201B in white light emission period W.

Referring to FIG. 14, first, white period color optimization unit 6022 performs a comparison in magnitude on minimum required light amounts Wr, Wg and Wb of the R, G and B light beams calculated by white period setting unit 6020 (step S201). In the example shown in FIG. 13, the values of minimum required light amounts Wr, Wg and Wb of the R, G and B light beams are “64”, “160” and “80”; therefore, a relation of Wr<Wb<Wg is established.

Next, with regard to the middle value among minimum required light amounts Wr, Wg and Wb, that is, the value of minimum required light amount Wb, white period color optimization unit 6022 calculates an optimized value Wbopt that allows the display of all the pixels without lacking color balance, in the case where the maximum value of “160”, that is, the value of minimum required light amount Wg is allocated to the value in white light emission period W (step S202).

Specifically, white period color optimization unit 6022 calculates a period during which DMD 40 is turned on in white light emission period W, for each pixel, based on signal value G(x) of the G signal and minimum required light amount Wg of the G light beam. Then, white period color optimization unit 6022 calculates a minimum amount of a B light beam to be required for displaying a white component in the period during which DMD 40 is turned on. When signal value G(x) exceeds the value of minimum required light amount Wg of the G light beam, DMD 40 is turned on throughout the white light emission period. Therefore, a relation of G(x)=Wg is established. White period color optimization unit 6022 sets the maximum value among the calculated minimum required light amounts of the B light beams of all the pixels at optimized value Wbopt for the middle value, that is, the value of minimum required light amount Wb, in accordance with the following expression (6).

$${W}_{bopt} = max ( \frac{{W}_{g}}{G ( x )} \times ( B ( x ) - {B}_{pure} ) ) \qquad ( 6 )$$

When optimized value Wbopt for the middle value, that is, the value of minimum required light amount Wb is calculated by the process described above, then, white period color optimization unit 6022 calculates an optimized value Wropt for the minimum value, that is, the value of minimum required light amount Wr (step S203). White period color optimization unit 6022 calculates a period during which DMD 40 is turned on in white light emission period W, for each pixel, based on signal value G(x) of the G signal, minimum required light amount Wg of the G light beam, signal value B(x) of the B signal, and optimized value Wbopt for the value of minimum required light amount Wb of the B light beam. Then, white period color optimization unit 6022 calculates a minimum amount of an R light beam to be required for displaying a white component in the period during which DMD 40 is turned on. Herein, when signal value G(x) exceeds the value of minimum required light amount Wg of the G light beam, a relation of G(x)=Wg is established. Likewise, when signal value B(x) exceeds optimized value Wbopt for the value of minimum required light amount Wb of the B light beam, a relation of B(x)=Wbopt is established. White period color optimization unit 6022 sets the maximum value among the calculated minimum required light amounts of the R light beams of all the pixels at optimized value Wropt for the minimum value, that is, the value of minimum required light amount Wr, in accordance with the following expression (7).

$${W}_{ropt} = max ( max ( \frac{{W}_{g}}{G ( x )} , \frac{{W}_{bopt}}{B ( x )} ) \times ( R ( x ) - {R}_{pure} ) ) \qquad ( 7 )$$

Thus, the value of the minimum required light amount (Wr, Wg, Wb) of the light beam (R, G, B) in white light emission period W is adjusted to the optimized value (Wropt, Wgopt, Wbopt). In other words, white period color optimization unit 6022 changes a ratio of the amounts of the R, G and B light beams in white light emission period W, in accordance with RGB signals. With this configuration, it is possible to suppress the electric power consumption by single-color light sources 201R, 201G and 201B without lacking the color balance of an image in one frame.

### (Duty Extension)

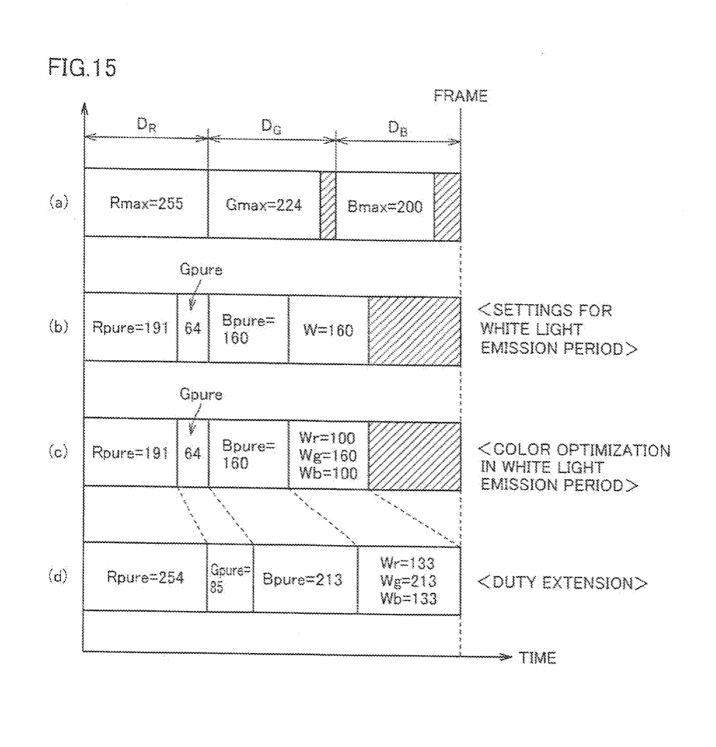

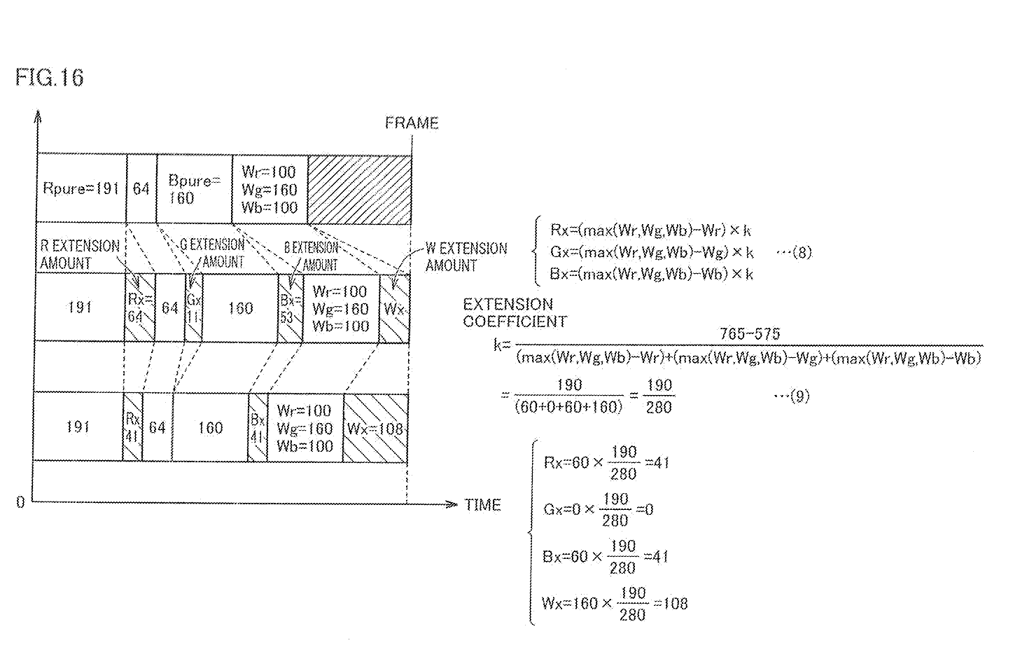

FIG. 15 is a graph illustrating operations for the Duty extension in step S03 shown in FIG. 11.

In FIG. 15, (a) shows an R light emission period R, a G light emission period G and a B light emission period B set based on the maximum values (Rmax, Gmax, Bmax=255, 224, 200) of the RGB signals shown in FIG. 12.

Also in FIG. 15, (b) shows a state that R, G and B single-color light emission periods Rpure, Gpure and Bpure as well as white light emission period W set by the operations for setting the white light emission period shown in FIG. 13 are relocated so as not to overlap. Herein, In the case of relocation of the R, G and B components as well as white component, the position of the white component is not particularly limited.

Also in FIG. 15, (c) shows a state that the value of the minimum required light amount (Wr, Wg, Wb) of the light beam (R, G, B) is adjusted to the optimized value by the operations for color optimization in the white light emission period shown in FIG. 14. In (c) of FIG. 15, a sum total of R, G and B single-color light emission periods Rpure, Gpure and Bpure as well as white light emission period W does not match with a frame period. Accordingly, signal conversion unit 6024 adjusts the R, G and B single-color light emission periods as well as white light emission period, and performs scaling such that the sum total of these periods matches with the frame period.

A Duty extending ratio (DER=765/415) is derived by substitution of the values in the single-color light emission periods (Rpure, Gpure, Bpure=191, 64, 160) and white light emission period (W=160) shown in (c) of FIG. 15 into the foregoing expression (2). Each single-color light emission period and the white light emission period are subjected to scaling using the calculated Duty extending ratio and, as the result, are extended (Rpure=254, Gpure=85, Bpure=213, W=213). Herein, the minimum required light amounts of the R, G and B light beams are increased (Wr, Wg, Wb=133, 213, 133) in white light emission period W.

### Modified Example

The foregoing description is given of the case where the R, G and B single-color light emission periods as well as the white light emission period are extended at the identical ratio in accordance with the common Duty extending ratio in the operations for Duty extension. Alternatively, higher brightness can be realized by using different Duty extending ratios for the R, G and B single-color light emission periods and the white light emission period such that the Duty extending ratio for the white light emission period becomes larger than the Duty extending ratio for the R, G and B single-color light emission periods.

FIG. 16 is a graph illustrating a modified example of the operations for Duty extension.

In FIG. 16, Rx denotes an extension amount of R single-color light emission period Rpure, Gx denotes an extension amount of G single-color light emission period Gpure, Bx denotes an extension amount of B single-color light emission period Bpure, and Wx denotes an extension amount of white light emission period W.

The amounts of the R light beam, G light beam and B light beam in white light emission period W are adjusted by the operations for color optimization in the white light emission period (see FIG. 14). Therefore, when only the Duty extending ratio in white light emission period W is made larger than Duty extending ratio DER described above, there arises a possibility that the lack in white balance occurs at an image.

In order to prevent such a possibility, in this modified example, extension amounts Rx, Gx, Bx and Wx of the respective light emission periods are determined such that a sum total of the values of the extension amounts of the respective light emission periods corresponds to white light. Specifically, an extension coefficient k is derived by substitution of the value of the minimum required light amount (Wr, Wg, Wb) of the light beam (R, G, B) adjusted by the operations for color optimization in the white light emission period into the following expression (9). Then, using calculated extension coefficient k, extension amounts Rx, Gx, Bx and Wx of the respective light emission periods are calculated from the following expression (8).

$$\begin{matrix}{R}_{x} = ( max ( {W}_{r} , {W}_{g} , {W}_{b} ) - {W}_{r} ) \times k \\ {G}_{x} = ( max ( {W}_{r} , {W}_{g} , {W}_{b} ) - {W}_{g} ) \times k \\ {B}_{x} = ( max ( {W}_{r} , {W}_{g} , {W}_{b} ) - {W}_{b} ) \times k & ( 8 ) \\ k = \frac{765 - ( {R}_{pure} + {G}_{pure} + {B}_{pure} + W )}{\begin{matrix}( max ( {W}_{r} , {W}_{g} , {W}_{b} ) - {W}_{r} ) + ( max ( {W}_{r} , {W}_{g} , {W}_{b} ) - {W}_{g} ) + \\ ( max ( {W}_{r} , {W}_{g} , {W}_{b} ) - {W}_{b} )\end{matrix}} & ( 9 )\end{matrix}$$

As the result, since extension amount Wx of the white light emission period is increased as shown in FIG. 16, a projected image is improved in brightness. Moreover, in the white light emission period, because minimum required light amount Wr of the R light beam and minimum required light amount Wb of the B light beam are smaller than minimum required light amount Wg of the G light beam, extension amount Rx of the R light emission period and extension amount Bx of the B light emission period are made larger than extension amount Gx of the G light emission period. With this configuration, it is possible to keep the white balance of an image.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A projection type video display apparatus comprising:
a light source unit that includes a plurality of single-color light sources emitting light beams of different wavelengths;
a light modulation element that modulates the light beam emitted from said light source unit to form image light, based on an input video signal;
a projection unit that projects the image light formed by said light modulation element; and
a control unit that controls actuation of said light source unit, wherein
said control unit includes:
a video signal analysis unit that analyzes said video signal for each image data on a frame basis;
a light emission period setting unit that sets a single-color light emission period in which at least two single-color light sources of said plurality of single-color light sources emit the light beams in a time division manner and a multiple-color light emission period in which at least two single-color light sources of said plurality of single-color light sources emit the light beams simultaneously, within one frame period, based on the result of analysis by said video signal analysis unit; and
a light emission period color adjustment unit that changes a ratio between amounts of the light beams emitted from said at least two single-color light sources in said multiple-color light emission period set by said light emission period setting unit, in accordance with the result of analysis by said video signal analysis unit.

2. The projection type video display apparatus according to claim 1, wherein
each of said plurality of single-color light sources has a characteristic that light emission efficiency is reduced as a drive current becomes large.

3. The projection type video display apparatus according to claim 1, wherein
each of said plurality of single-color light sources is an LED light source.

4. The projection type video display apparatus according to claim 1, wherein
said video signal analysis unit analyzes a signal value of each pixel which forms said image data, and
said light emission period setting unit sets said single-color light emission period and said multiple-color light emission period such that a sum total of values in said single-color light emission period and said multiple-color light emission period is minimized, based on said signal value of each pixel.

5. A video display apparatus comprising:
an image light formation unit that emits light beams of different wavelengths, and modulates said light beam to form image light, based on an input video signal;
an image display unit that displays the image light formed by said image light formation unit; and
a control unit that controls said image light formation unit, wherein
said control unit includes:
a video signal analysis unit that analyzes said video signal for each image data on a frame basis;
a light emission period setting unit that sets a single-color light emission period in which the light beams of at least two wavelengths are emitted in a time division manner and a multiple-color light emission period in which the light beams of at least two wavelengths are emitted simultaneously, within one frame period, based on the result of analysis by said video signal analysis unit; and
a light emission period color adjustment unit that changes a ratio between amounts of said emitted light beams of at least two wavelengths in said multiple-color light emission period set by said light emission period setting unit, in accordance with the result of analysis by said video signal analysis unit.
